(19) United States
(12) Patent Application Publication
(10) Pub. No.: US 2007/0186188 A1
(43) Pub. Date: Aug. 9, 2007

(54) Method and System for Linking Objects with Graphical User Interface Items

(75) Inventor: Robert Harris, Dorset (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/462,097

(22) Filed: Aug. 3, 2006

(30) Foreign Application Priority Data
Aug. 4, 2005 (GB) 0516017.1

(51) Int. Cl. G06F 3/048

(52) U.S. Cl. 715/835

(57) ABSTRACT

A method and system for linking installed objects with referencing items in a computer system are provided. An object installed on a computer system has a linking between the object and items referencing the object, such as GUI items for accessing the object. Changes to the object are linked to the referencing items by the linkage. This avoids the problem or orphaned items when the object is removed.

This invention relates to the field of graphical user interface (GUI) items. In particular, this invention relates to providing a linkage from objects to GUI items.

Installation of software on a GUI-based system (such as Microsoft Windows) generally creates icons in a menu (such as that engendered from the “Start” button in Windows) along with the text of the item. These are often arranged in hierarchies such as Programs.MSOffice.MSWord. When the software is installed, a user usually gets the choice of the part of the hierarchy into which the icons are placed (MSOffice in the above example). When the software is deleted via its standard software removal process, the whole hierarchy is deleted (MSOffice and anything contained lower down in this example). This results in a clean removal of the software with nothing extraneous left on the system. (Microsoft Windows, MSOffice, MSWord are trade marks of Microsoft Corporation in the United States, other countries or both.)

However, in a more common case, the user has altered the hierarchy. For example, by renaming part of it (renaming MSOffice to “Microsoft Office” yielding an hierarchy of Programs.Microsoft Offices.MSWord in the above example). In this case, when the software is deleted the hierarchy is not deleted as the removal process only knows about the items created at installation time.

In addition, various copies of the icons representing program execution can be made. These should also be deleted on software removal but are often overlooked. For example, in the Windows environment, orphaned icons on the desktop or mini-icons in the Quick Launch Bar result. The term “orphaned” is used herein to refer to an item that references an object that is not accessible (for example, as the object has been deleted, moved or renamed etc.). Consequently, orphaned menus and icons that are attempted to be accessed cause problems (object not found conditions etc.).

Additionally, if an object is moved from the folder into which it was installed, the software removal process cannot remove it as it does not now know where the object resides. In other words, the software removal process requires that the state at removal is exactly the same in all respects as it was at installation time.

In the example of Microsoft Windows, GUI items such as icons and menu items are GUI-based artifacts. They contain the names of the objects that they reference or access, but, as they are not File System constructs, when an object's name or location changes the reference can be invalidated leaving the GUI item orphaned.

The aim of the present invention is to provide a linkage between an object installed on an operating system and items referencing or accessing the object. The object may be an executable object, for example, a software application or program, an executable routine such as a DLL (dynamic-link library), etc. The object may be non-executable but access via an indirection from an item. Items may be, for example, desktop icons, quick access items, menu items, etc.

An advantage of the present invention is that software removal does not leave orphaned GUI items but instead enables a complete software removal. By adding the proposed linkage, when an object is deleted (either manually or by software removal procedures) the linked items such as menu items/icons are also deleted. Consequently, the items do not become orphaned, and so redundant and erroneous items do not occur.

The proposed linkage also permits several additional operations not currently automatically provided including automatic reconfiguration of referencing items when an object is renamed or moved.

According to a first aspect of the present invention there is provided a method for linking installed object with referencing items in a computer system, comprising: installing an object on a computer system; creating one or more items referencing the object; and providing a linkage between the object and the referencing items, wherein changes to the object are linked to the referencing items by the linkage.

The object is preferably an executable object and the items are graphical user interface items for accessing the object.

The method may include creating a linkage when a referencing item is created. The referencing items may have details of the object embedded in them.

The linkage is preferably amended when the object is altered. When the object is altered, the method may include scanning the linkage to detect the referencing items and amending the detailed of the object embedded in the referencing items.

According to a second aspect of the present invention there is provided a system for linking installed objects with referencing items in a computer system, comprising: means for installing an object on a computer system; means for creating one or more items referencing the object; and a linkage between the object and the referencing items, wherein changes to the object are linked to the referencing items by the linkage.

The items may be graphical user interface items for accessing the object.

The linkage may be a registry with a identifier of the object and metadata providing details of the referencing items. In another embodiment, the linkage may be metadata providing details of the referencing items stored with the object. In a further embodiment in an object file system, the linkage may be metadata providing details of the referencing items contained in the object. In a yet further embodiment, the linkage may be provided by a log in which details of all changes to the object or referencing items are stored.

A file system Application Program Interface (APE) for installing an object may include means for creating the linkage. Alternatively, an API may be invoked by the file system API when installing an object to create the linkage.

An API for creating a referencing item may include means for adding detailed to the linkage of the referencing item.

According to a third aspect of the present invention there is provided a computer program product stored on a computer readable storage medium, comprising computer readable program code means for performing the steps of: installing an object on a computer system; creating one or more items referencing the object; and providing a linkage between the object and the referencing items, wherein changes to the object are linked to the referencing items by the linkage.

Embodiments of the present invention will now be described, by way of examples only, with reference to the accompanying drawings in which:

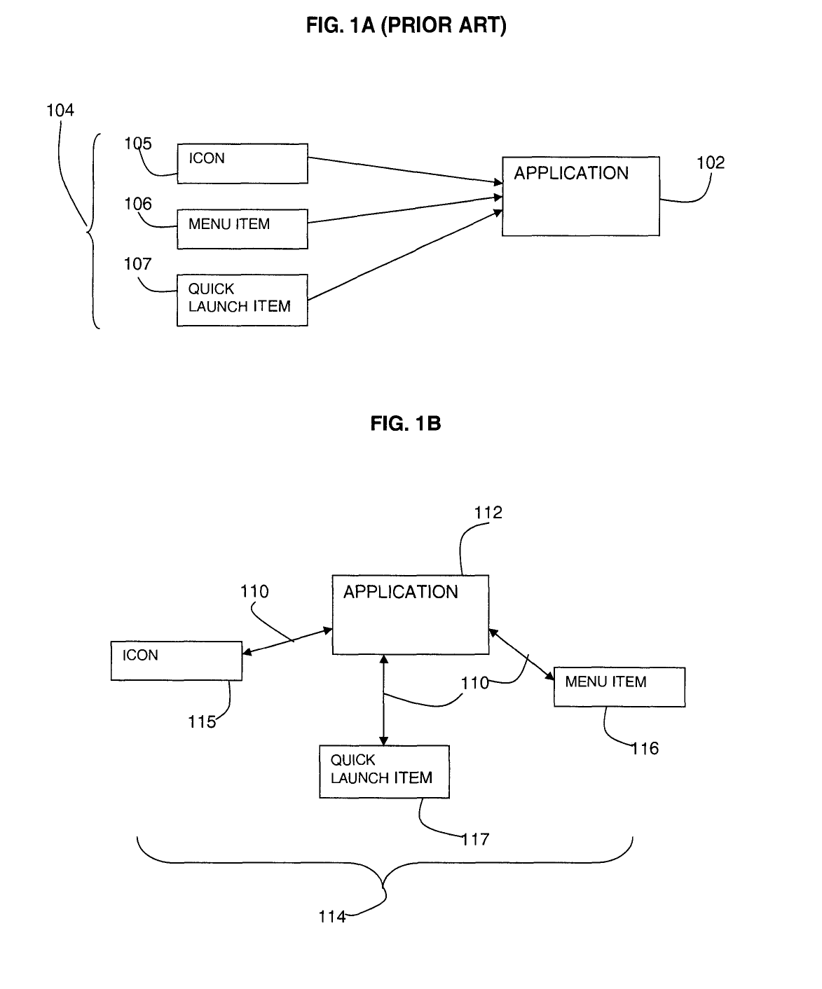

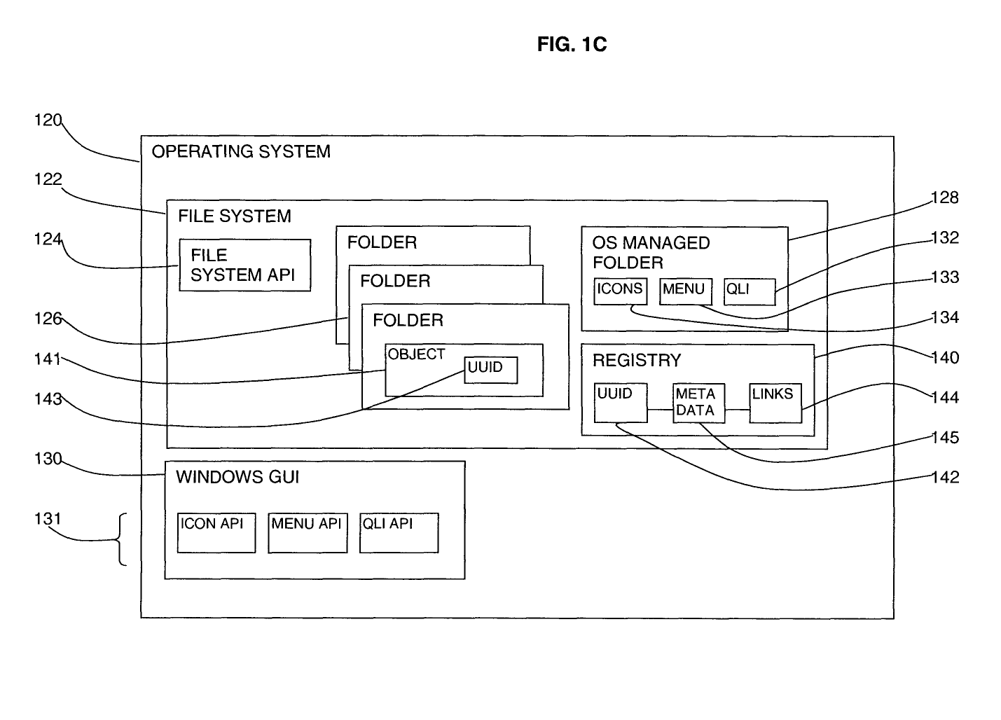

FIG. 1A is a schematic representation of GUI-based items referencing an object as know in the prior art;

FIG. 1B is a schematic representation of GUI-based items referencing an object in accordance with the present invention;

FIG. 1C is a block diagram of an operating system with a file system in accordance with the present invention;

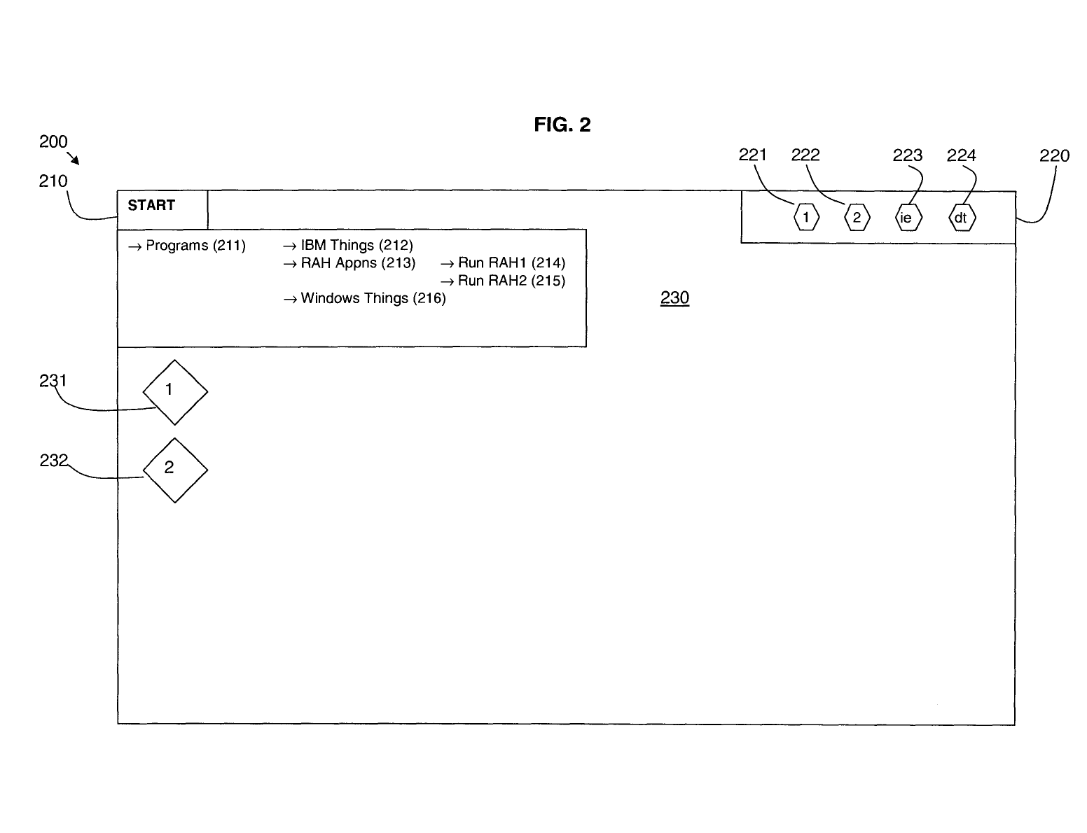

FIG. 2 is a representation of a desktop in a windows-based GUI as known in the prior art;

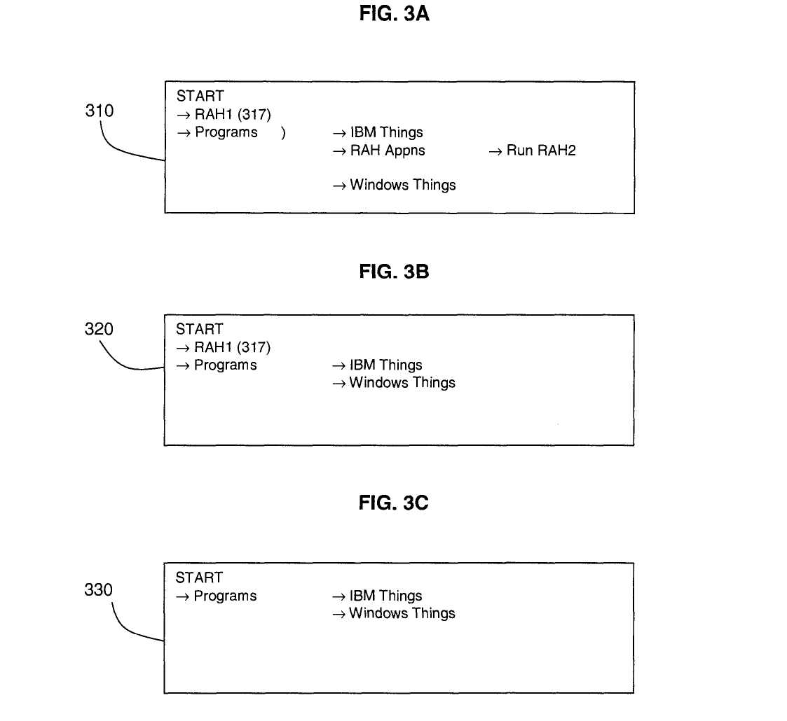

FIGS. 3A to 3C are details of embodiments of the menu of FIG. 2;

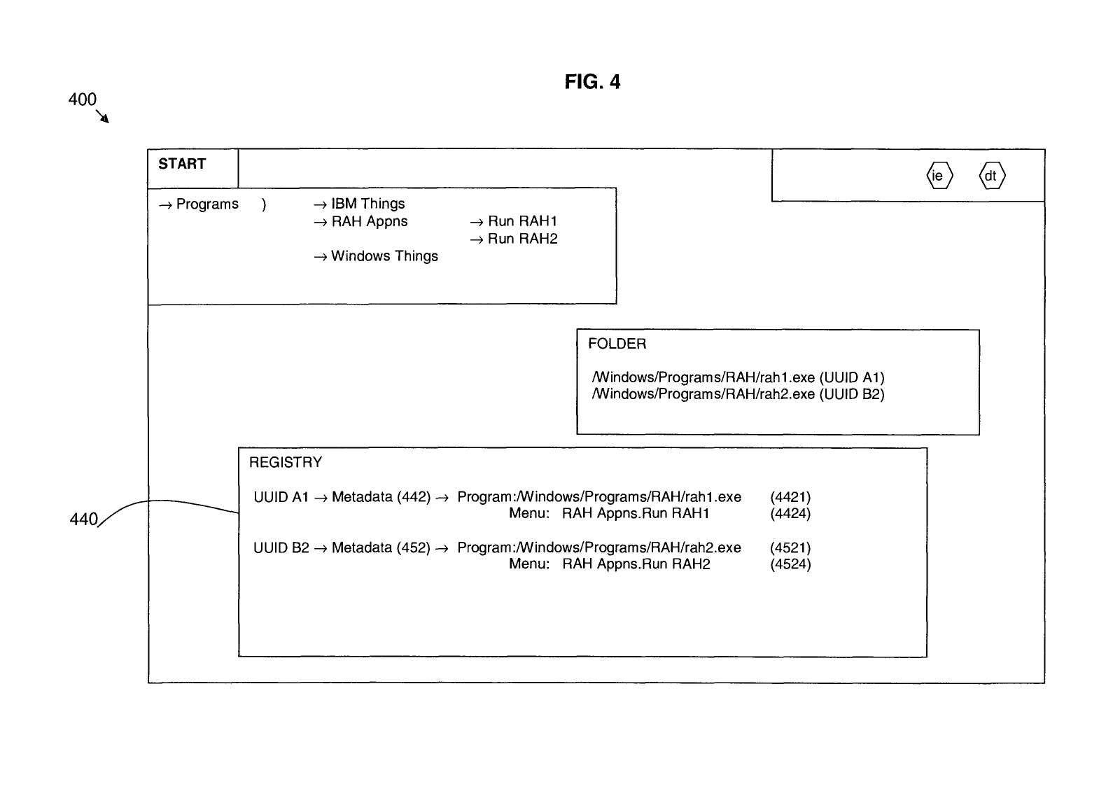

FIG. 4 is a representation of a desktop in a windows-based GUI in accordance with the present invention with an objects installed in the form of two applications;

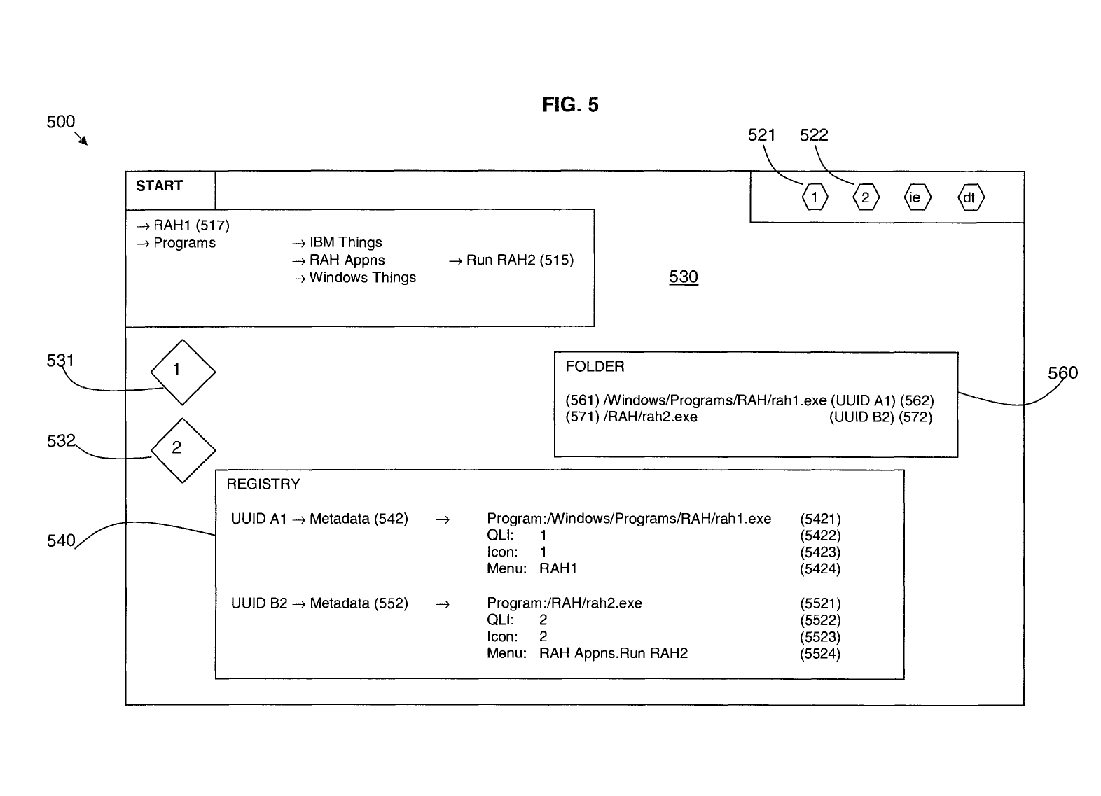

FIG. 5 is a representation of the desktop of FIG. 4 with referencing items added;

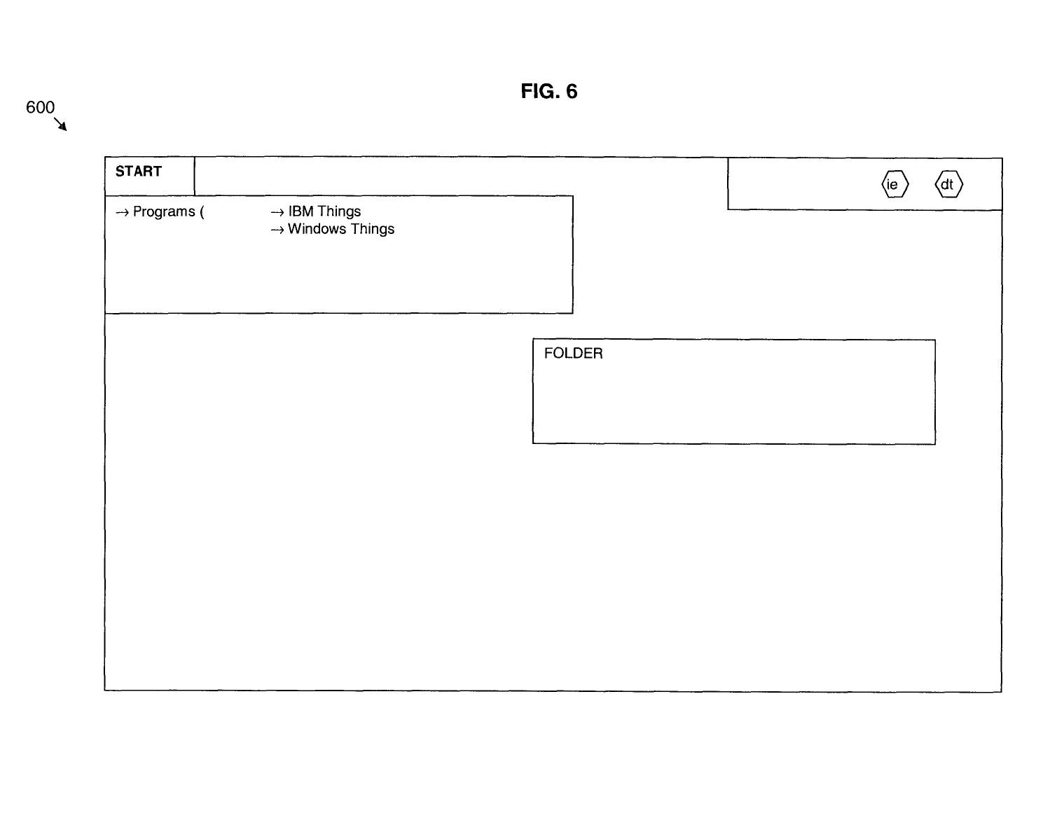

FIG. 6 is a representation of the desktop FIG. 4 with the objects removed;

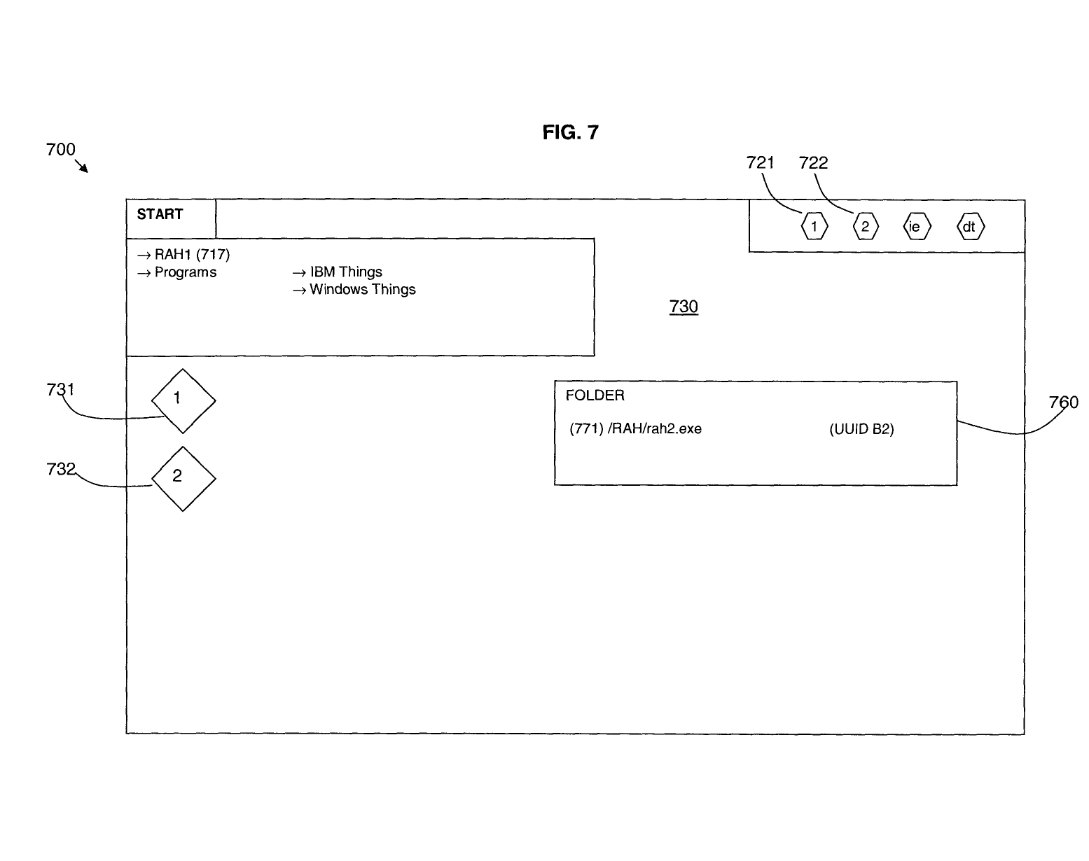

FIG. 7 is a representation of the desktop of FIG. 4 with orphaned items as known in the prior art;

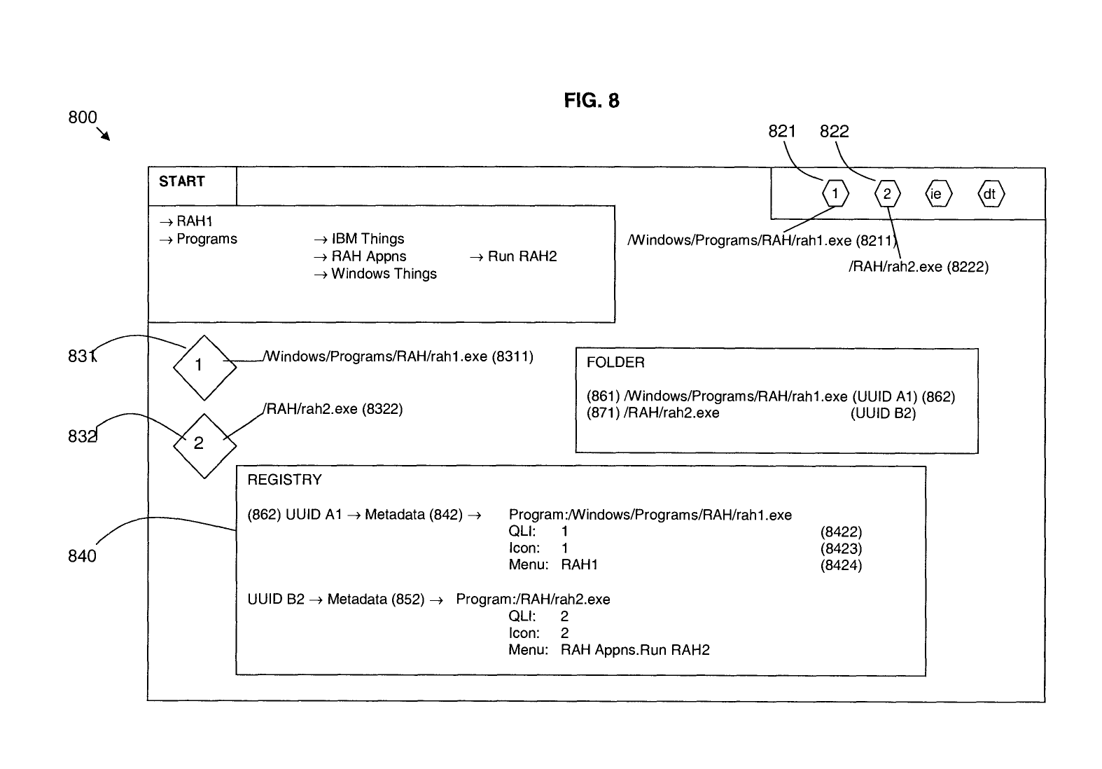

FIG. 8 is a representation of the desktop of FIG. 4 showing embedded locations of the object in the referencing items;

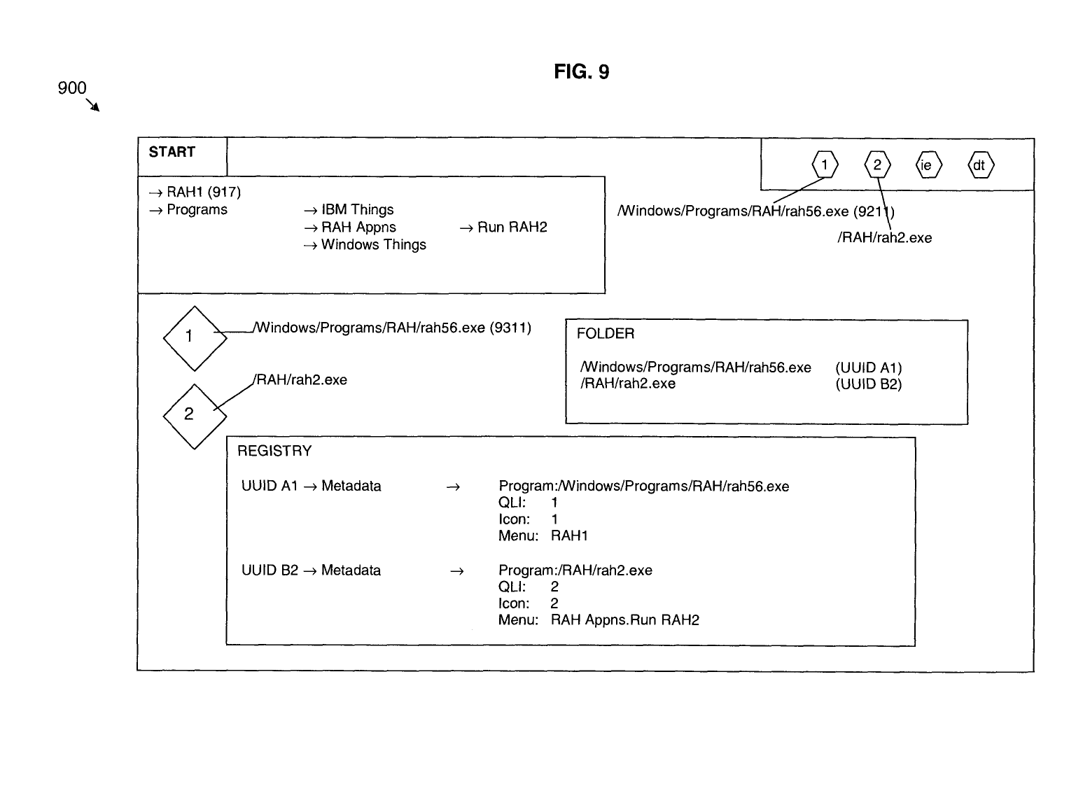

FIG. 9 is representation of the desktop of FIG. 4 with a change of name of an item;

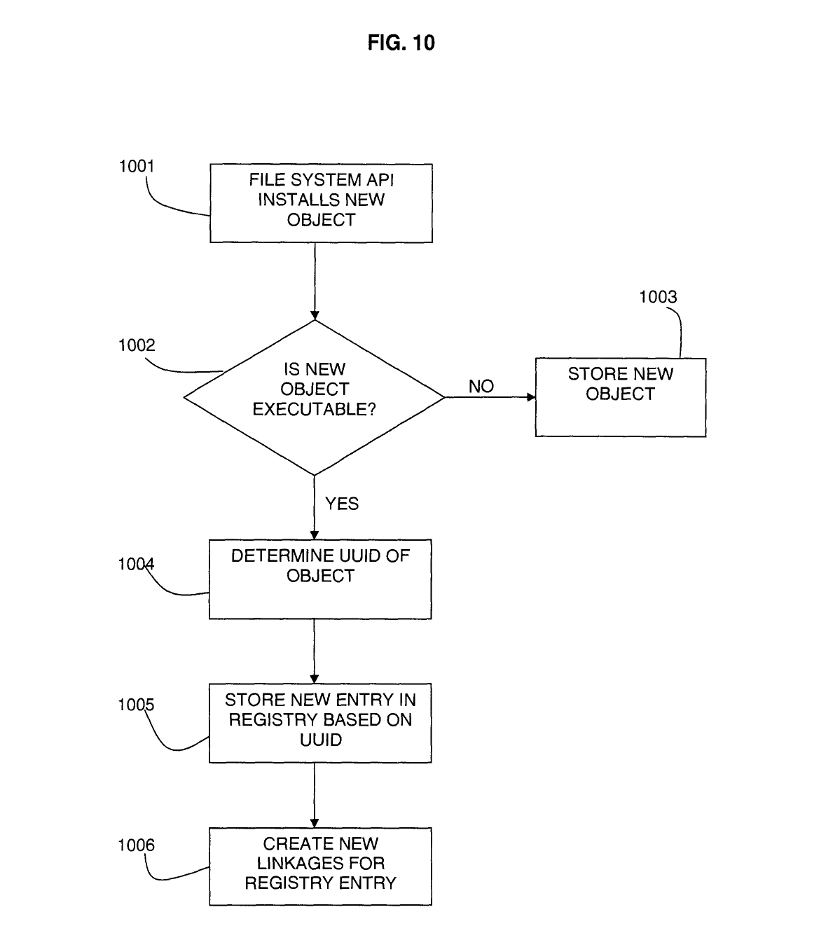

FIG. 10 is a flow diagram of a process of installing an object in accordance with the present invention;

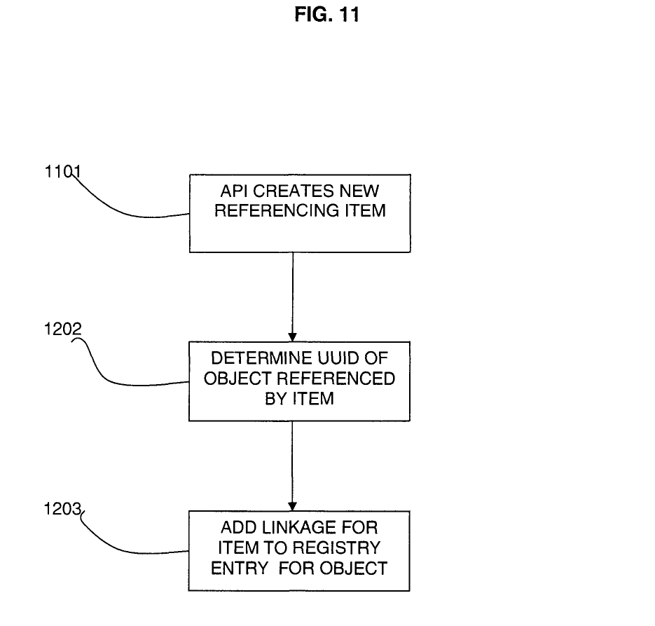

FIG. 11 is a flow diagram of a process of creating a referencing item in accordance with the present invention; and

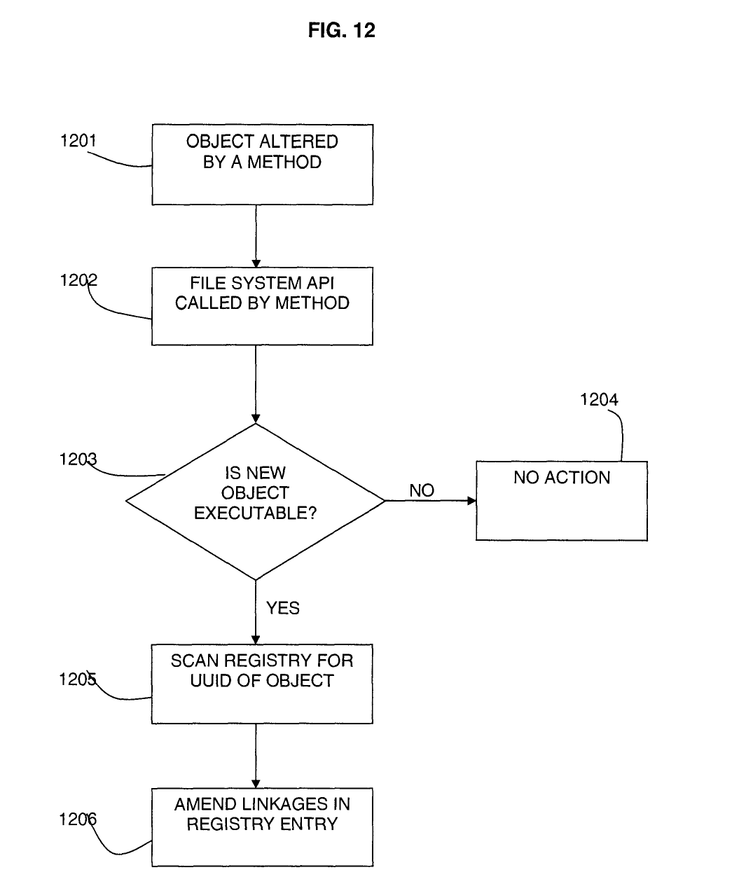

FIG. 12 is a flow diagram or a process of altering an object in accordance with the present invention.

In the description of the implementation, Microsoft Windows is used as the GUI environment. The principles described generally apply to all other GUI environments used within the UNIX®/LINUX™ community such as those provided by Sun Solaris (Xopen), the Free Software Foundation (Gnome etc.), K Desktop Environment, etc. (UNIX is a registered trademark of the Open Group in the United States and other countries. Linux is a trademark of Linux Torvalds in the United States, other countries, or both, other company, product or service names may be trademarks or service marks of others.)

A method and system are provided with a linkage between an object installed on an operating system and items referencing or accessing the object. The object may be an executable object, for example, a software application or program, an executable routine such as DLL (dynamic-link library), etc. The object may be non-executable but referencing an executable object. Items may be, for example, desktop items, quick access items, menu items, etc.

FIG. 1A shows a representation of the prior art wherein an object in the form of a software application 102 is referenced by GUI items 104 such as a desktop icon 105, a menu item 106 and a quick launch item 107.

FIG. 1B shows a representation of the present invention in which an object in the form of a software application 112 has a two way linkage 110 with GUI items 114 such as a desktop icon 115, a menu item 116 and a quick launch item 117.

A general implementation of the present invention changes a one-way representation of an underlying system object on a GUI screen as shown in FIG. 1A into a double way linkage so that alteration of the basic object also effects the items that refer to it.

When an object is installed on an operating system, it is input in a known place with a known name. GUI items which reference the object may be created at the installation of the object or may be created subsequently but, in both cases, they reference the object at by its known name and known location. During the course of housekeeping exercises or other operations the name of the object may be changed, it may be moved, or it may be deleted. The solution presented records extra information providing a linkage between the object and any related items.

Referring to FIG. 1C, an example embodiment is provided in the Microsoft Windows environment. An operating system 120 of a computer system has a file system 122 which is a structure in which files are named, stored and organized. The file system 122 includes a file system API (Application Programming Interface) 124 and folders 126 in which files are stored.

The operating system 120 also has a GUI 130 including APIs 131 for creating desktop icons 132, menu items 133, and quick access items 134. An operating system managed folder 128 in the file system 122 includes details of the icons 132, menu items 133 and quick access items 134.

The file system 122 includes a registry 140 which provides the linkage between objects and GUI items such as the icons 132, 133, 134.

When an object is installed, it is placed into a directory from where it is executed. It also has a globally unique name often referred to an a UUID. This UUID is logged in the registry 140 whereby it is used at initiation time of the object to provide metadata associated with the environment for the execution of that object.

UUIDs are often generated by reference to the network card used within the environment that the OUID owner was generated in together with a timestamp to give the unique quality.

An object 141 in the form of an .exe file is installed on the operating system 120. The act of placing an .exe file into the file system 122 uses the file system API 124. The file system API 124 can be extended to take additional notice of the fact that the item is executable (the .exe file extension already has associated processing on it) and so creates the new entries 142 in the registry 140 based on the UUID 143 of the .exe. This implementation has the advantage that the file 122 inserts the registry 140 entries, and so avoids any special action to be taken as part of the installation process.

When the object 141 is executed, the UUID 142 is looked up in the registry 140 to extract metadata 145 relating to its execution

In the UNIX paradigm, the act of making the object an executable (via File Attributes in the File System) triggers this operation.

In an embodiment of the present invention, the API which registers the object 142 in the registry 140 (by placing the UUID 143 in the registry 140) is extended to create the linkages 144. Alternatively, a new API is provided to do this operation and this is invoked as part of the installation process.

The act of creating an item such as a desktop icon, menu item or quick launch item uses an API 131 to create it. These respective APIs 131 are extended to add in the required registry entries for linkages 144 to the items 132, 133, 134.

An example embodiment is described in which software applications named RAH1 and RAH2 are installed on the operating system. The applications are stored in the locations C:/Windows/Programs/RAH/rah1.exe; C:/Windows/Programs/RAH/rah2.exe. Upon installation, the applications have unique identifiers (UUIDs) stored in a registry together with metadata relating to the applications.

Referring to FIG. 2, an example display 200 of a windows-based GUI is shown. The display is used in the subsequent FIGS. 4 to 9 to illustrate the operation of the present invention with the same reference numbers used for corresponding features in the figures with the replacement of the first digit to represent the current figure.

In FIG. 2, the display 200 includes a pull-down menu 210 showing the location of object icons in the operating system in their position in hierarchies. In this example, the software applications RAH1 214 and RAH2 215 are in a hierarchy of “RAH Applications” 213. A top level hierarchy of “Programs” 211 includes “RAH Applications” 213 together with “IBM Things” 212 and “Windows Things” 216.

The display 200 has a desktop 230 on which are placed icons for access to documents, databases, applications, etc. A quick launch toolbar 220 is also provided with items such as the date/time 224 and a quick launch for the Internet 223.

The applications RAH1 214 and RAH2 215 have desktop icons 231, 232 associated with them and quick launch items 221, 222 for ease of execution in the windows environment.

In the windows environment, the icons 221, 222, 231, 232 contain the graphic representation of the icon together with the name and location of the application (C:/Windows/Programs/RAH/rah1.exe for example).

In the prior art, when a software removal action is run, icons 221, 231 are erroneously left as they were created by the user and were not generated as part of the software installation process. In terms of the menu 210, the installation of the applications has created a new hierarchy “RAH Applications” 213 containing items representing RAH1 214 and RAH2 215. As RAH Applications 213 was created as part of the software installation process, the software removal process can remove it.

Referring to FIGS. 3A and 3C, the evolution of a menu system is shown. After a time, the menu 310 may be change to the configuration shown in FIG. 3A in which the execution of application RAH1 has been moved into a new position 317 in the top level of the menu hierarchy. In this case, when the software is uninstalled leading to the menu 320 shown in FIG. 3B, application RAH1 317 is left orphaned as the removal process does not know about the hierarchy alteration.

The described method and system would overcome this problem and the menu 330 shown in FIG. 3C would result whereby the orphaned application RAH1 317 is additionally removed as required and expected by the user.

Referring to FIG. 4, in accordance with the present invention, the metadata associated with the applications additionally records the newly created program linkages. In the display 400, the registry 440 is illustrated which contains the metadata 442, 452 for the applications 4421, 4521 and the menu locations 4424, 4524. The software installation process creates the initial metadata settings.

Referring to FIG. 5, the creation of items which refer to the program (such as the quick launch items) also adds in entries to the relevant metadata. In this example, the desktop icons 531, 532 and the quick launch items 521, 522 are created. The linkages 5422, 5423, 5522, 5523 providing information relating to the items is added to the metadata 542, 552 in the registry 540. The registry 540 now contains the information relating to the new items in the quick launch toolbar 521, 522 and the on the desktop 531, 532.

The entries in the metadata relating to the menu items 5424, 5524 have been amended to show the new locations of RAH1 561 and RAH2 571 in the hierarchy. In the case of application RAH2 571 which has been moved to a new folder, the UUID 572 is unchanged, so the movement alters the metadata location 5521 in the registry 540. The movement also observes that the application RAH2 has associated links 5522, 5523, 5524 in the metadata relating to items which access the application. These items which are the menu item 515, the quick launch item 522 and the desktop icon 532 for application RAH2 are altered to point to the new location of the application thus removing an error when they are selected.

When the quick launch items 521, 522 and the desktop icons 531, 532 are created, the act of creation in addition to placing the current location of the executable object in the item, also updates the registry metadata for the executable object.

Consequently, the provision of the linkages in the registry 540 ensures that when the software removal proceeds, access is made to the registry 540 for the relevant UUIDs of RAH1.exe 562 and RAH2 572 so that all associated items can be removed. This scan picks up the quick launch items 521, 522 via the metadata entries 5422, 5522 and so can remove them. In the same fashion the desktop icons 5423, 531, 5523, 541 and the menu items 5424, 517, 5524, 515 are removed along with the actual applications 5421, 561, 5521, 571 which have also changed location.

Therefore, when software removal is performed, the environment reverts to the display 600 shown in FIG. 6. Whereas the prior are would lead to the display 700 shown in FIG. 7 which has orphaned items 721, 722, 717, 731, 732 all of which when selected result in error. Additionally, the application RAH2 771 should have been removed but has been left in the folder 760 as it was moved from its original installation location.

If an object is copied, the UUID stays the same and the registry can record a plurality of locations (as it does for icons and menu items) so ensuring that all copies are deleted at software removal time.

In the case where the object is moved, renamed or deleted, the file system is used to detect the operation and take the appropriate action. Thus, if an object is renamed (this can be done via a command-line command of a GUI-based operation) a file system API will be called to do the renaming operation. This API is extended by the to carry additional actions if the item is an executable object (a .exe). The additional actions include: looking at the registry; scanning for the UUID of the executable (which does not change); and picking up the registry entries and adjusting them accordingly. Consequently, if the object is renamed (by whatever method) the file system API doing the change will examine the registry, detect what executable object the icons, menu items or quick launch items are using, and change the name of the object as required. Similarly, if the object moves locations. In the case of a deletion, then the linked items are merely deleted.

Referring to FIGS. 8 and 9, an example is illustrated in which the application RAH1 is renamed RAH56. In FIG. 8, the display 800 shows that quick launch items 821, 822 have embedded within them the physical location of the executable 8211, 8222. Similarly, for icons on the desktop 831, 8311 and 832, 8322 and items in the menu 861, 871.

If application RAH1.exe shown in FIG. 8 to RAH56.exe, the renaming side effect generated on the file system rename operation, scans down the registry entry 840 based on the UUID 862 of the application to determine all the linked items 842. It then detects the linked items 8422, 8423, 8424 and alters them to contain the new name of the application 9211, 9311, 917 as shown in FIG. 9.

FIG. 10 shows a flow diagram of the process of installing an object on an operating system. A file system API installs 1001 a new object. It is determined 1002 if the object is an executable. If not, it stores 1003 the object in a new folder. If the object is an executable, the UUID is determined 1004. A new entry is stored 1005 in the registry based on the UUID. The file system API or an invoked API create linkage entries 1006 in the registry.

FIG. 11 shows a flow diagram of the process of creating a referencing item such as a desktop icon, a quick launch item or a menu item. An API creates 1101 the new referencing item. The UUID of the object referenced by the item is determined 1102 and registry linkages are added 1103 to the object entry in the registry identifying the item.

FIG. 12 shows a flow diagram of the process of altering an object, for example, by renaming, moving or deleting the object. The object is altered 1201 by a method and a file system API is called 1202. It is determined 1203 if the object is an executable and, if not, no action is taken 1204. If the object is an executable, the API scans 1205 the registry for the UUID of the object and changes 1206 any register links for the object.

In the described embodiment the UUID and the registry are used as the key to creating the reverse linkage for installed objects. In the general case, outside Windows-based environments, the current folder location is used as the linkage. Associated metadata (which can be held externally in a registry or physically held in the file system along with the installed object) provides the required linkage. A function of the file system detects the movement/renaming/deletion of the executable object and follows the linkages provided via the registry and associated metadata to alter/delete the linked items.

In an object file system, the executable objects themselves contain the linkages as part of their metadata (in general, a collection of reverse linkages) so that the object file system can perform the actions described.

In another embodiment, a log of all menu hierarchy/icon/location changes is maintained and this is scanned as part of the software removal process to remove dangling icons. It is also manipulated each time an item is moved, created, renamed or deleted. This embodiment might best be suitable for a Transactional File System whereby the log and the items whose properties are recorded therein are atomic.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

1. A method for linking installed objects with referencing items in a computer system, comprising;
installing an object on a computer system;
creating one or more items referencing the object; and
providing a linkage between the object and the referencing items, wherein changes to the object are linked to the referencing items by the linkage.

2. A method as claim in claim 1, wherein the object is an executable object.

3. A method as claimed in claim 1, wherein the items are graphical user interface items for accessing the object.

4. A method as claimed in claim 1, including creating a linkage when a referencing item is created.

5. A method as claimed in claim 1, wherein the referencing items have details of the object embedded in them.

6. A method as claimed in claim 1, wherein the linkage is amended when the object is altered.

7. A method as claimed in claim 5, wherein when the object is altered, scanning the linkage to detect the referencing items and amending the detail of the object embedded in the referencing items.

8. A system for linking installed objects with referencing items in a computer system, comprising:
means for installing an object on a computer system;
means for creating one or more items referencing the object, and
a linkage between the object and the referencing items, wherein changes to the object are linked to the referencing items by the linkage.

9. A system as claimed in claim 8, wherein the object is an executable object.

10. A system as claimed in claim 8, wherein the items are graphical user interface items for accessing the object.

11. A system as claimed in claim 8, wherein the referencing items have details of the object embedded in them.

12. A system as claimed in claim 8, wherein the linkage is a registry with an identifier of the object and metadata providing details of the referencing items.

13. A system as claimed in claim 8, wherein the linkage is metadata providing details of the referencing items stored with the object.

14. A system as claimed in claim 8, wherein in an object file system, the linkage is metadata providing details of the referencing items contained in the object.

15. A system as claimed in claim 8, wherein the linkage is provided by a log in which details of all changes to the object or referencing items are stored.

16. A system as claimed in claim 8, wherein a file system API for installing an object includes means for creating the linkage.

17. A system as claimed in claim 8, wherein an API is invoked by the file system API when installing an object to create the linkage.

18. A system as claimed in claim 8, wherein an API for creating a referencing item includes means for adding details to the linkage of the referencing item.

19. A computer program product stored on a computer readable storage medium, comprising computer readable program code means for performing the steps of:
installing an object on a computer system;
creating one or more items referencing the object; and
providing a linkage between the object and the referencing items, wherein changes to the object are linked to the referencing items by the linkage.
